(19) United States
(12) Patent Application Publication
(10) Pub. No.: US 2007/0268415 A1
(43) Pub. Date: Nov. 22, 2007

(54) Vehicle mounted display apparatus and sound controlling method

(75) Inventors: Nobutaka Ukyou, Hyogo (JP); Tadashi Sato, Hyogo (JP)

Correspondence Address: OLIFF & BERRIDGE, PLC, P.O. BOX 19928, ALEXANDRIA, VA, 22320, US

(73) Assignee: FUJITSU TEN LIMITED, KOBE-SHI (JP)

(21) Appl. No.: 11/703,770

(22) Filed: Feb. 8, 2007

(30) Foreign Application Priority Data
May 22, 2006 (JP) 2006-141242

(51) Int. Cl. H04N 9/31; H04R 5/00

(52) U.S. Cl. 348/760; 381/17; 348/E09.025

(57) ABSTRACT

A display is operable to simultaneously display, on a single screen, a first image in a direction of a driver's seat based on a first image source, and a second image in a direction of a passenger's seat based on one of the first image source and a second image source. A sound controller is operable to localize a sound image corresponding to at least one of the first image and the second image. The sound controller localizes the sound image corresponding to the second image based on a type of the second image source in a case where the second image is displayed based on the second image source.

The disclosure of Japanese Patent Application No. 2006-141242 filed May 22, 2006 including specification, drawings and claims is incorporated herein by reference in its entirety.

### BACKGROUND OF THE INVENTION

The present invention relates to a vehicle mounted display apparatus and sound controlling method for the vehicle mounted display apparatus.

Japanese Patent Publication No. 2005-078080A discloses a multi-view display in which different images can be visualized from different directions on a single display screen, simultaneously. In addition, Japanese Patent Publication No. 2005-101979A discloses an apparatus in which individual audio outputs are provided to individual viewers by a plurality of high directional frequency characteristic speakers as an audio output unit of reproducing apparatus having the multi-view display.

In a vehicle mounted navigation apparatus having the multi-view display, a navigation image can be visualized from a driver's seat side and a DVD image or the like can be visualized from a passenger's seat side. In this case, since the navigation image on the driver's seat side is not visible to an occupant in a passenger's seat, the occupant in the passenger's seat can concentrate on a display image such as a movie even inside a vehicle. On the other hand, as to the acoustic environment, although the viewer of the image is the occupant in the passenger's seat, a sound image is normally localized to a position between the driver's seat and the passenger's seat. With a DVD of a movie or the like, in many cases, the sound effect becomes important, and the acoustic environment suitable for DVD appreciation is unnecessary for the driver who is not appreciating the DVD image. Therefore, the sound setting needed to be adjusted so that the occupant in the passenger's seat could appreciate the DVD in a good acoustic environment. In addition, since the occupant in the passenger's seat was less accustomed to controlling the apparatus than the driver, the occupant in the passenger's seat had difficulty in controlling the apparatus properly with the same control display.

### SUMMARY OF THE INVENTION

It is therefore an object of the invention to provide acoustic environments suitable for viewers. And it is also an object of the invention to enhance controllability by the users.

In order to achieve the above described objects, according to the invention, there is provided a vehicle mounted display apparatus, comprising:

a display operable to simultaneously display, on a single screen, a first image in a direction of a driver's seat based on a first image source, and. a second image in a direction of a passenger's seat based on one of the first image source and a second image source; and

a sound controller operable to localize a sound image corresponding to at least one of the first image and the second image, wherein: the sound controller localizes the sound image corresponding to the second image based on a type of the second image source in a case where the second image is displayed based on the second image source.

The sound controller may localize the sound image to the passenger's seat in a case where the type of the second image source is a video source of a DVD or a video source of a television.

The sound controller may include a sound mode selecting section operable to select, based on the type of the second image source, one of a normal sound mode in which the sound image is localized to at least a position between the driver's seat and the passenger's seat, and a passenger's seat sound mode in which the position of the sound image is localized to at least the passenger's seat.

The vehicle mounted display apparatus may further comprise:

a display mode switching section operable to switch a display mode between a single display mode in which the second image is displayed based on the first image source and a dual display mode in which the second image is displayed based on the first image source;

a display mode judging section operable to judge the display mode;

a source judging section judging the type of the second source in a case where the display mode judging section judges the display mode is the dual display mode.

The sound mode selecting section may select the passenger seat sound mode in a case where the source judging section judges that the type of the second source is a video source of a DVD or a video source of a television.

The sound mode selecting section may select the normal sound mode in a case where the source judging section judges that the type of the second source is a navigation image.

The sound mode selecting section may select the normal sound mode in a case where only a driver rides in a vehicle.

The vehicle mounted display apparatus may further comprise:

a speaker disposed in the vicinity of the driver's seat and operable to output a navigation guiding sound.

The vehicle mounted display apparatus may further comprise:

a speaker disposed in the vicinity of the driver's seat and operable to output a sound corresponding to the first image.

According to the invention, there is also provided a sound controlling method for a vehicle mounted display apparatus having a display operable to simultaneously display, on a single screen, a first image in a direction of a driver's seat based on a first image source and a second image in a direction of a passenger's seat based on one of the first image source and a second image source, the sound control method comprising:

judging whether the second image is displayed based on the first source or the second source;

judging a type of the second source in a case where the second image is displayed based on the second source;

localizing a sound image corresponding to one of the first image and the second image to at least the passenger's seat in a case where the type of the second source is a video source;

localizing the sound image to at least a position between the driver's seat and the passenger's seat in a case where the type of the second source is not the video source.

The video source may be a video source of a DVD or a video source of a television.

The type of the second source may include a navigation image.

The sound controlling method may further comprise:

detecting a number of passengers;

localizing the sound image to at least the position between the driver's seat and the passenger's seat in a case where the number of the passengers is one.

According to the invention, since an optimum sound setting is automatically implemented based on the type of the image source of the image displayed on the multi-view display, a labor hour spent by the viewer changing manually the sound setting is saved.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a diagram of a vehicle mounted multi-view display apparatus according to an embodiment of the present invention;

FIG. 2 is a schematic diagram showing a sectional construction of a display unit of the vehicle mounted multi-view display apparatus;

FIG. 3(a) is a diagram showing the vehicle mounted display;

FIG. 3(b) is a diagram showing the vehicle mounted display;

FIG. 4 is a perspective view showing an installation example of the vehicle mounted display apparatus according to the embodiment of the present invention;

FIG. 5 is a functional block diagram of the vehicle mounted display apparatus;

FIG. 6 is a functional block diagram of a display device and a sound control device of the vehicle mounted display apparatus;

FIG. 7(a) is a diagram showing an example of a display image in a single display mode;

FIG. 7(b) is a diagram showing an example of a display image in a dual display mode;

FIG. 8 is a diagram showing an acoustic environment within a vehicle;

FIG. 9 is a flowchart of the sound control device;

FIG. 10 is a diagram showing combinations of sound modes with image sources;

FIG. 11 is a flowchart of the display device; and

FIGS. 12(a) to 12(d) are examples of display images which are displayed on the vehicle mounted display apparatus.

### DETAILED DESCRIPTION OF THE EMBODIMENTS

Hereinafter, embodiments of a vehicle mounted display apparatus and a sound controlling method according to the invention will be discussed with reference to the accompanying drawings.

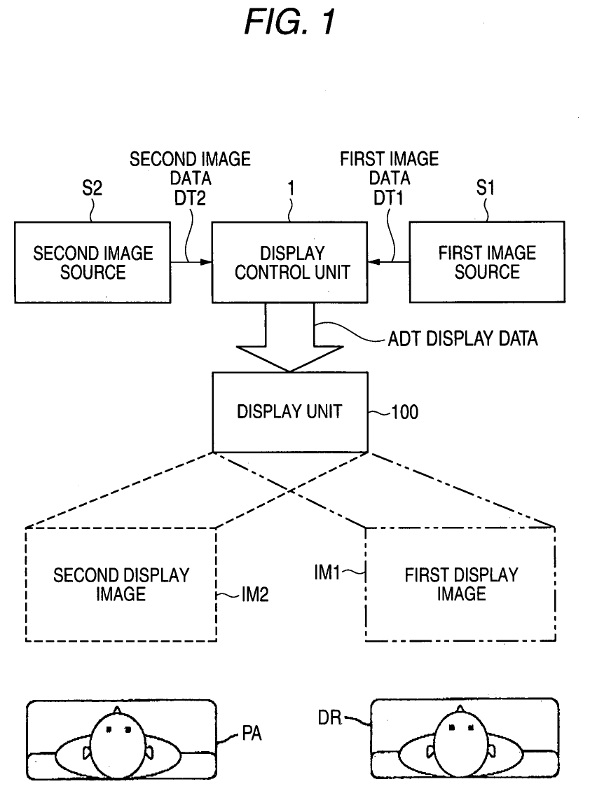

As shown in FIG. 1, in a vehicle mounted multi-view display apparatus according to an embodiment of the invention, according to relative positions of observers such as a driver (a driver's seat) DR and a passenger (the passenger's seat) PA to a display unit 100, in other words, according to angles of view relative to the display unit 100a, the driver DR and the passenger PA can view a first image IM1 and a second image IM2, respectively, substantially at the same time (simultaneously) on a single screen. Namely, the first image IM1 is viewable only from the driver DR and the second image IM2 is viewable only from the passenger PA. Moreover, each of the images IM1, IM2 can be displayed over the whole of a display screen of the display unit 100 to be viewed.

The vehicle mounted display apparatus includes a display control unit 1, the display unit 100. The display control unit 1 receives image data DT1 and image data DT2 which are supplied thereto from a first image source S1 as a supply source and a second image source S2 as a supply source, respectively, and outputs image data ADT which includes the first and the second image data DT1, DT2 to the common display unit 100.

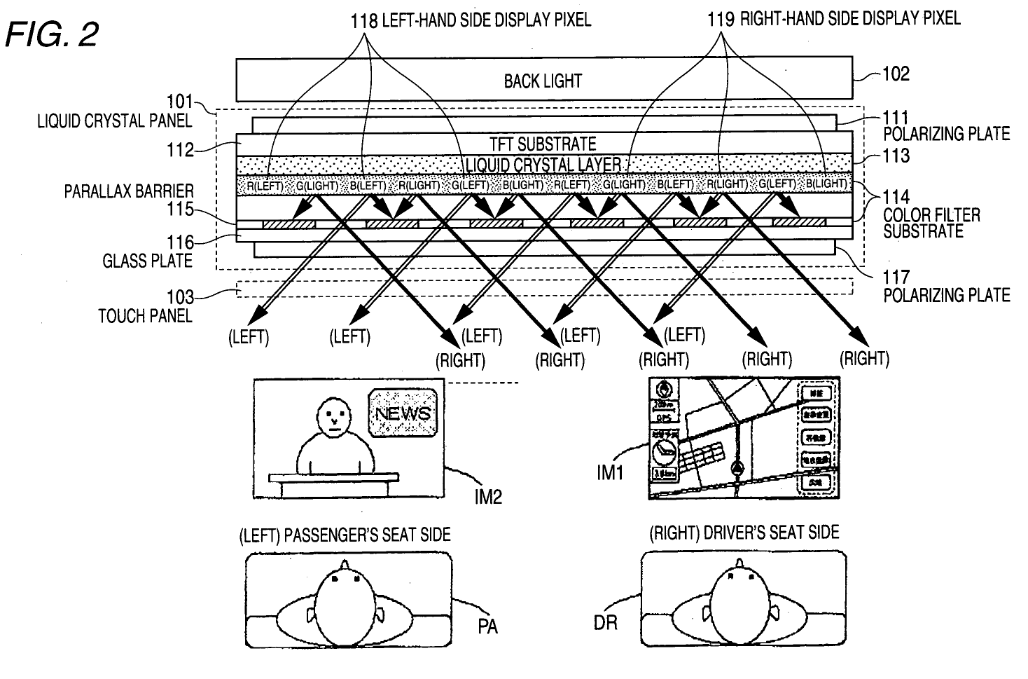

As shown in FIG. 2, the display unit 100 includes a liquid crystal panel 101, a back light 102, a parallax barrier 115, a touch panel 103. The liquid crystal panel 101 has a construction in which a polarizing plate 111, a TFT (Thin Film Transistor) substrate 112, a liquid crystal layer 113, a color filter substrate 114 which has pixels of three first colors of RGB, the parallax barrier 115, a glass plate 116, and a polarizing plate 117 are arranged sequentially in that order from a back light 102 side thereof This liquid crystal panel 101 has a display screen on which for example, 800 pixels are arranged in a horizontal direction and 480 pixels are arranged in a vertical direction, and on this display screen, left-hand side (the passenger's seat side PA) display pixels 118 and right-hand side (the driver's seat side DR) display pixels 119 are arranged alternately in the horizontal direction. In addition, the parallax barrier 115 has a construction in which shielding portions and light transmitting portions are arranged alternately, and light which has passed through the right-hand side display pixels and light which has passed through the left-hand side display pixels are caused to pass rightwards and leftwards, respectively, by the parallax barrier 115, whereby the first image IM1 can be visualized from a right part (the driver's seat side DR) of the liquid crystal panel 101, and the second image IM2 can be visualized from a left part (the passenger's seat side PA) thereof. Parallax barriers disclosed in Japanese Patent Publication No. 10-123461A and Japanese Patent Publication No. 11-084131A can be applied to the parallax barrier 115. In addition, the touch panel 103 is formed into a transparent sheet and is then affixed to a front surface of the liquid crystal panel 101. Note that when the first and the second image sources S1, S2 are identical, the left-hand side and right-hand side users can view the same image.

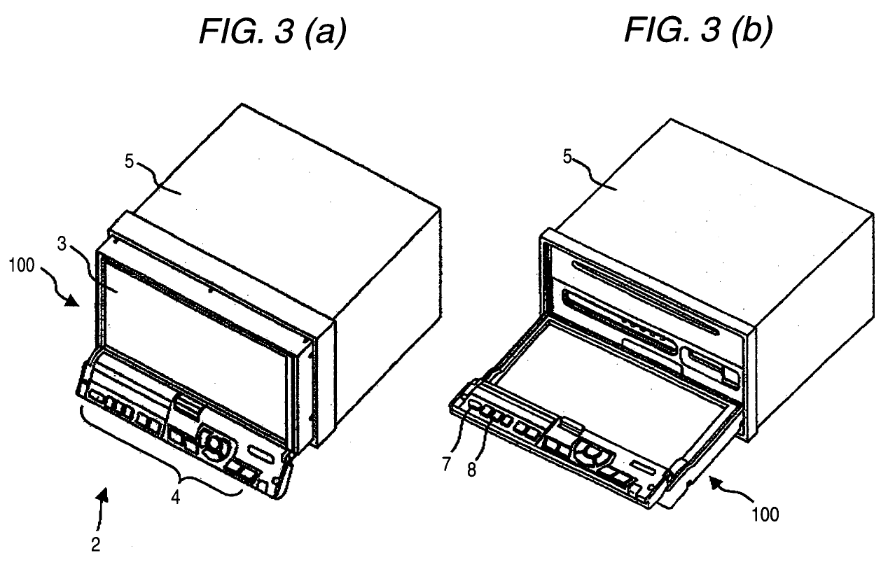

As shown in FIGS. 3(a) and 3(b), the vehicle mounted display apparatus 2 includes the display unit 100 which has a display screen 3 and a control unit 4 and a main body unit 5. As is shown in FIG. 3(a), the display unit 100 is used in such a state that the display unit 100 is accommodated in a frame provided on a front circumference of the main body unit 5. In addition, as shown in FIG. 3(b) the display unit 100 can be tilted (inclined) for adjustment of an angle relative to the main body, and the display unit 100 is constructed to be manipulated to open the main body unit 5, so that a CD or a DVD and a storage medium such as a semiconductor memory can be inserted into and dislocated from the main body unit 5 from a front side thereof.

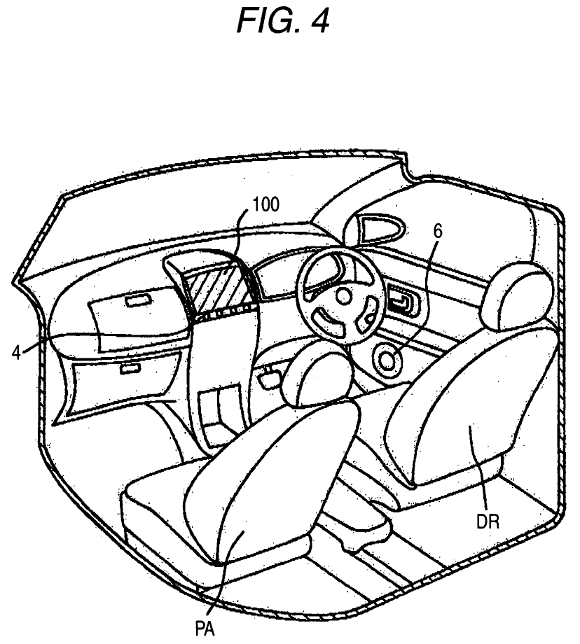

As is shown in FIG. 4, the display unit 100 is disposed on a dashboard portion of the vehicle in a position lying between a driver's seat DR and a passenger's seat PA, and a driver DR and a passenger in the passenger's seat or front seat seated passenger PA can view the first image IM1 and the second image IM2, respectively, which are displayed differently on the region of the display unit 100 at the same time. In addition, the control unit 4 for manually controlling the vehicle mounted display apparatus 2 on the display unit 100. A speaker 6 is disposed in each door of the vehicle so as to output sound corresponding to a displayed image (the first image IM1 and the second image IM2) and warnings.

By having as image sources, navigation, television, DVD and the like together with the configuration described above, for example, the occupant PA can enjoy viewing a television program or a DVD at the same time that the driver DR is being given a driving support from a car navigation system. Moreover, since each of the images is represented by use of the whole of a 7-inch screen, for example, there occurs no case where the screen size is reduced as has occurred with a conventional multi-window display. Namely, information or contents are provided in an optimum form to each of the driver and the occupant, respectively, as if they were using their own independently dedicated display.

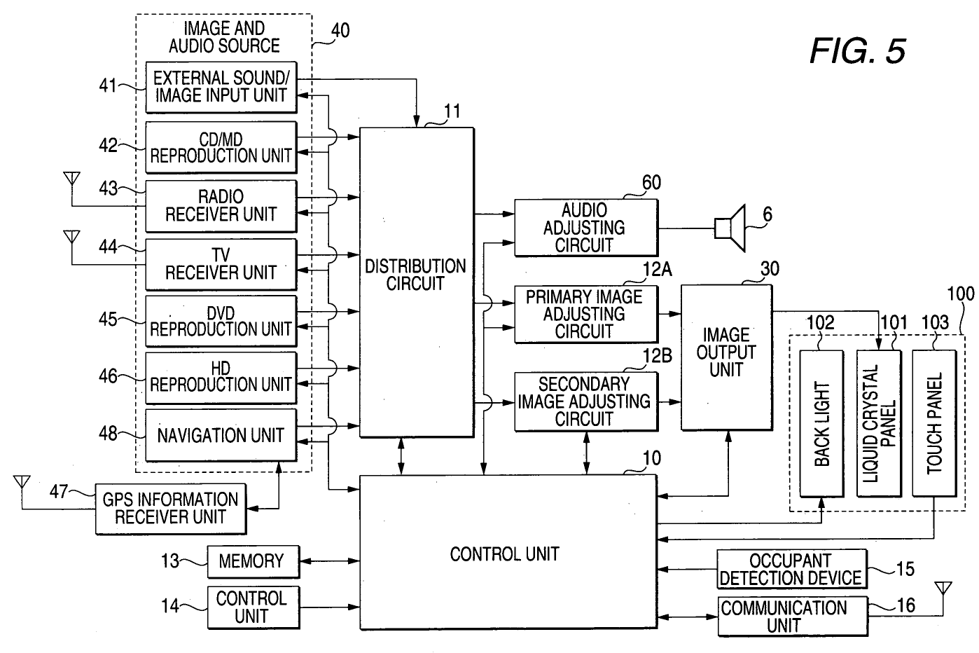

As is shown in FIG. 5, the vehicle mounted display apparatus includes the display unit 100, a control unit 10, a distribution circuit 11, first and second image quality adjusting circuits 12A, 12B, an image output unit 30, an audio output unit 60.

The control unit 10 is connected to an external audio/image input unit 41 for inputting sound and images from the outside which functions as an image and audio source (a supply source) which is mounted on the vehicle to supply images and sound, a CD/MD (Compact Disc/Mini Disc) reproduction unit 42, a radio receiver unit 43, a TV receiver unit 44, a DVD reproduction unit 45 which reproduces musical information and images from a DVD (Digital Versatile Disc), an HD reproduction unit 46 which reproduces images and musical information which are recorded on an HD (hard disc), a navigation unit 48 which outputs a map and a route guiding image based on geographical information received by a GPS information receiver unit 47 and the like, and sends and receive data between these constituent components, while controlling them. In addition, an external memory 13 which stores various data, a control unit 14 which is displayed on the touch panel 103 or is provided on the periphery of the display unit 100 to control the vehicle mounted display apparatus 2 or select and change the contents to be displayed, an occupant detection sensor 18 for detecting an occupant of the vehicle, which includes pressure-sensitive sensors which are provided in the driver's seat and the passenger's seat are also connected to the control unit 10, whereby the control unit 10 can perform various controls based on various data obtained from these constituent components so connected.

The memory 13 includes, for example, a non-volatile memory such as a flash memory which can electrically be rewritten or a non-volatile memory which is backed up by a battery, and stores data which is necessary for controls by the control unit 10. To be specific, the memory 13 stores, for example, setting information for setting a visible area, which will be described later, and vehicle information such as the position of a steering wheel of the vehicle.

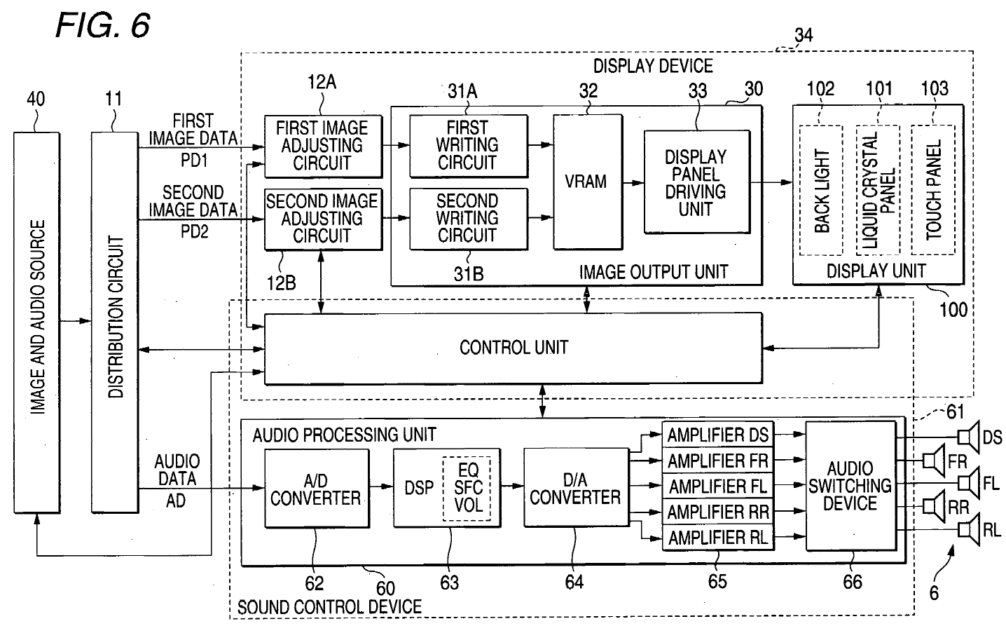

As is shown in FIGS. 5 and 6, the distribution circuit 11 distributes audio data AD and image data PD which are supplied from the aforesaid image and audio source 40 to an audio processing unit 60, the first image quality adjusting circuit 12A or the second image quality adjusting circuit 12B according to a control command from the control unit 10. Although not shown, the first and second image quality adjusting circuits 12A, 12B are each includes a contrast adjusting unit, a luminance adjusting unit, a color tone adjusting unit, a gamma value adjusting unit, and adjusts image qualities (contrast, luminance, color tone, gamma value) of the first and second image data PD1, PD2 according to a control command from the control unit 10. The adjusted image data PD1, PD2 are displayed on the display unit 100 which is the display device 34 via an image output unit 30. In addition, in the image output unit 30, the first and second image data PD1, PD2 which have been so adjusted are written and synthesized in a predetermined address in a VRAM (Video RAM) 32 via first and second writing circuits 31A, 31B. The synthesized image data corresponds to each pixel of the liquid crystal panel 101, and a display panel driving unit 33 drives corresponding pixels of the liquid crystal panel 101 based on the synthetic data held in the VRAM 32.

On the other hand, the distributed audio data AD is outputted to the speakers 6 (DS to RL) via the acoustic control device 61. The acoustic control device 61 includes the audio processing unit 60, the control unit 10. In the audio processing unit 60, audio data is converted into a digital signal by an A/D converter 62, and various audio processings are implemented at a DSP 63 (Digital Signal Processor). The processed audio data is converted into an analog signal by a D/A converter 64 and are then amplified by amplifiers 65 (DS to RL), and sound selected by an audio switching device 66 is outputted from the individual speakers 6. The various audio processings represents a processing at an EQ (Equalizer) with respect to sound quality, a processing at an SFC (Sound Field Control) with respect to acoustic effect such as reflecting sound and echo sound, and a processing at a VOL (Volume) with respect to volume or the like. In addition, a vehicle mounted acoustic apparatus includes the control unit 10 and the audio processing unit 60, and the control unit 10 recognizes a selected image source and display mode and controls the audio processing unit 60 to set an optimum acoustic environment according to the image source and display mode so recognized.

With the above described configuration, when the display mode is switched from a single display mode to a dual display mode so that the occupant views a video image such as a DVD, the sound mode can be changed from a normal sound mode to a passenger's seat sound mode, so that a good acoustic environment can be provided to the occupant in the passenger's seat without a labor hour consuming operation.

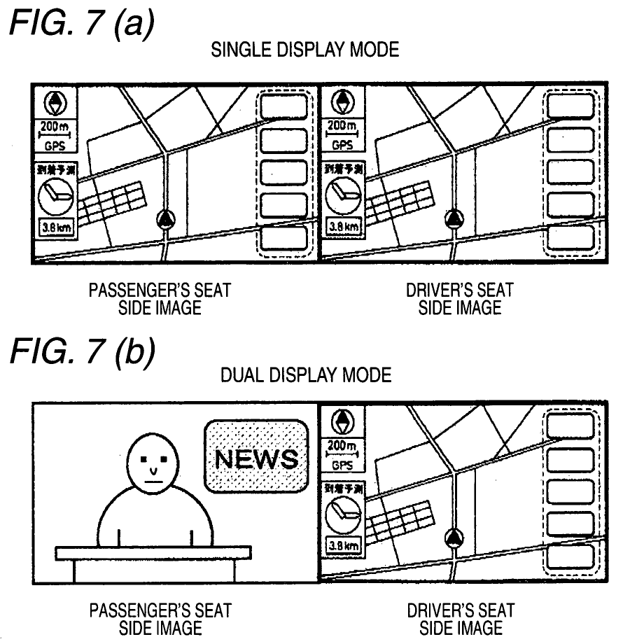

Here, the display mode will be described. The single display mode means a state in which the first image source S1 and the second image source S2 are the same image source and the same image is displayed on first and second screens based on this single source. In other words, the first image IM1 is displayed on the first and the second screens based on the first image source S1. As is shown in, for example, FIG. 7(a), a driver's seat side image and a passenger's seat side image are displayed as the same navigation image, and it substantially looks like one image is displayed on a normal single screen. On the other hand, the dual display mode means a state in which the first image source S1 and the second image source S2 are different image sources, and the first image IM1 and the second image IM2 are displayed on the first and second screens, respectively, based on the different image sources or the same image source. As shown in FIG. 7(b), by controlling a source selection control, a navigation image is displayed as the driver's seat side image and a TV (video) image is displayed as the passenger's seat side image, so that the driver DR and the passenger PA can view the different images. In the single display mode, an instruction inputted by operating control buttons displayed on the display unit via the touch panel 103 or the control unit 14 placed on a peripheral portion of a frame of the display unit 100 is reflected to the images displayed on both the screens. For example, when the display of a TV image is instructed via, for example, the control unit 14 or the like, a TV image is displayed on the first and second screens. Also in the dual display mode, however, although there is a case where the driver's seat side image and the passenger's seat side image are the same, the dual display mode differs from the single display mode in that the control can be carried out separately for each of the screens. In addition, although not shown, in the dual mode display state, although a TV image is displayed as the driver's seat side image and the passenger's seat side image, when a predetermined restriction (restriction on viewing a video while the vehicle is running) is put into effect, the output of the driver's seat side image is restricted, while the TV image is left displayed as the passenger's seat side image. Furthermore, the switching between the single display mode and the dual display mode can be implemented by a display mode switching device 7 such as a changeover switch. In addition, which of the first image IM1 and the second image IM2 to be operated (selection of control right) may be selected by a selection device 8.

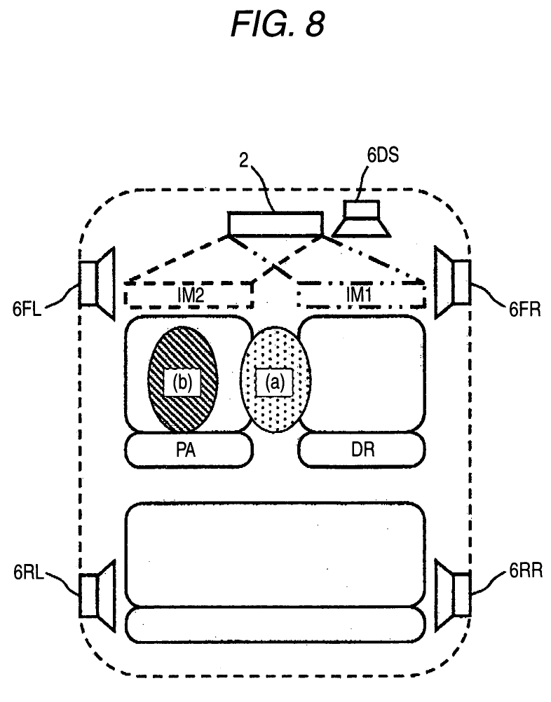

Next, the sound mode will be described. The normal sound mode means a sound setting for the single display mode, that is, the images are displayed as if they were displayed on the normal single screen. For example, in the case of the position of an sound image which constitutes an intersecting point of sounds outputted from the individual speakers 6 and constitutes a central position of the sounds, the sound image is localized to a position between the driver's seat and the passenger's seat so that the occupants in the driver's seat and the passenger's seat can listen to the audio equally ((a) in FIG. 8). On the other hand, the passenger's seat sound mode means an sound setting in which more consideration is given to the passenger (occupant) seated in the passenger's seat, and for example, the sound image is localized to the passenger's seat (the passenger's seat side)((b) in FIG. 8). In addition, no sound field effect is set in the normal sound mode, and in the passenger's seat sound mode, there may occur a case where the sound field effect is set to a sound field mode such as a live mode, a concert hall mode and a theater mode. Note that although there occurs a case where the normal sound mode and the passenger's seat sound mode are set to the same setting, it is preferably set such that the occupant is given an optimum acoustic environment. In addition, with both of the normal sound mode and the passenger's seat sound mode, the position (localization) of the sound image and the sound field effect can be changed. Furthermore, the sound field effect is such as to provide an acoustic environment which is given in, for example, a live site, a concert hall and a movie theater, so that the viewers can enjoy presence as if they were at such a place.

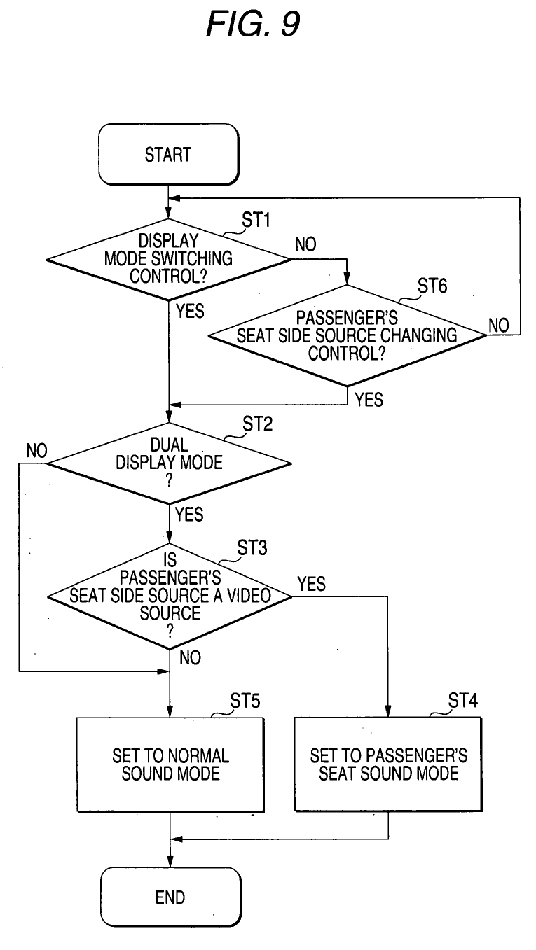

An example of a processing flow of the display device 34 is shown in FIG. 9. Firstly, a display mode switching operation by the control device 14 occurs (ST1), and if the display mode is determined to be the dual display mode (ST2), whether or not a source of the second image IM2 (the passenger's seat side) is a video (DVD, television or the like) source is determined (ST3). If the source of second image IM2 (the passenger's seat side) is determined to be a video source in ST3, the sound setting is set to the passenger's seat sound mode. Namely, the sound image localized to the passenger's seat (side) and the theater mode is set(ST4). By this setting, when the occupant switches the display mode to the dual display mode to attempt to view a video image, a good acoustic environment for the occupant can be set at the same time as the transition of the screen. On the other hand, if it is determined in ST2 that the current display mode is not the dual display mode, that is, is the single display mode, or if it is determined in ST3 that the source of the second image IM2 (the passenger's seat side) is not the video source, the acoustic setting is set to the normal sound mode (ST5). In this way, in the event that on other occasions than the occasion in which only the occupant views the video image, the sound setting is set to the normal sound mode so that the similar acoustic environment can also be provided to the driver, in the case of, for example, reproduction of music which is accompanied by no video image, the driver can also enjoy listening to the music while looking at a navigation image. In addition, in the event that an image source change displayed on the passenger's seat side is operated in place of operating the switching control of the display mode (ST6), the display mode is determined in ST3, and thereafter, the same processes as those described above will be followed. By adopting this configuration, in the dual display mode, for example, also when the occupant switches display image sources to the DVD wanting to view a DVD image while a navigation image is being displayed on both the driver's seat side and the passenger's seat side screens, the sound mode can be switched to the passenger's seat sound mode.

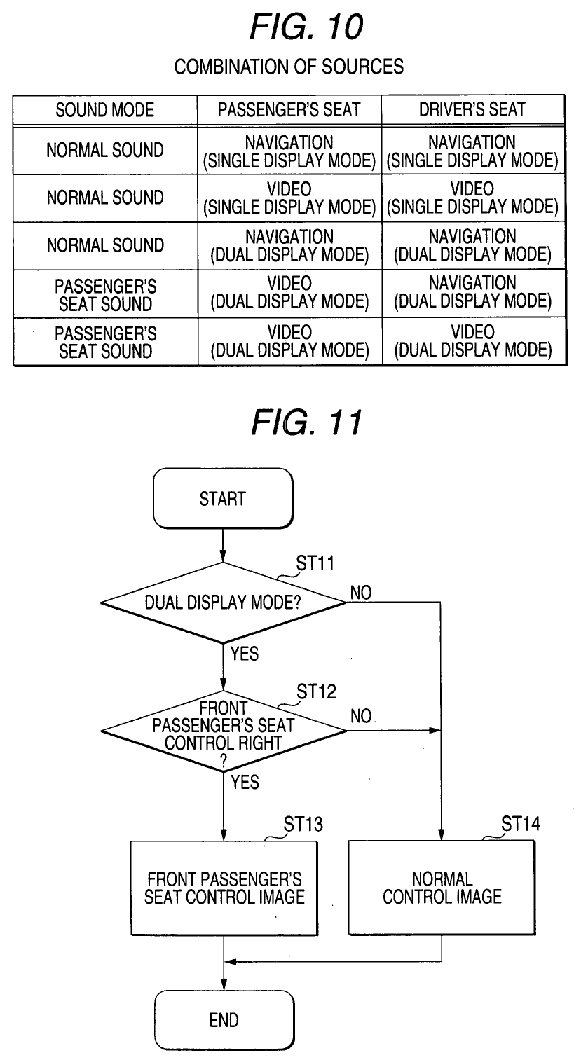

As is shown in FIG. 10, a type of the first and the second image source includes a video source and a navigation image. When the passenger's seat side image is a video image such as a DVD or television in the dual display mode, the sound mode is set to the passenger's seat sound mode, and with the other display mode and images, the sound mode is set to the normal sound mode. By adopting this configuration, when the occupant views a video image, the occupant can view the video image in an optimum acoustic environment, and when the occupant listens to music while looking at a navigation image not a video image, the driver can enjoy listening to the music in the same acoustic environment as that of the occupant. Here, the reason the passenger's seat sound mode is used in the dual display mode even though the same image source (video) is used for both the driver's seat side and the passenger's seat side is because the dual display mode is a display mode in which more consideration is given to the passenger's seat. For example, even with an image which cannot be viewed due to the restriction (the restriction on viewing at the time of running or the like) on a vehicle mounted display apparatus in which only a single image can be displayed on a single screen, since different images can be displayed on the driver's seat side and the passenger's seat side in the dual display mode, even though the driver's seat side image cannot be viewed due to the restriction, the passenger's seat side image can be viewed. Because of this, the occupant can view the image irrespective of the running state of the vehicle, and thus, the dual display apparatus can be said to be the display mode in which more consideration is given to the occupant. In addition, the reason the sound mode is set to the passenger's seat sound mode when the occupant views a video image is because a video image of a DVD or television is different from a navigation image in that in many cases, the viewer wants to concentrate on it, and by making the acoustic environment an optimum one for the occupant, the occupant can enjoy watching the image. Namely, when the occupant switches the display mode from the single display mode to the dual display mode to watch a video image, the occupant can appreciate the video image more simply and comfortably by switching the sound mode from the normal sound mode to the passenger's seat sound mode. By adopting this configuration, the occupant can set the sound setting to one which matches an image to be viewed by only switching the display mode so as to switch sources for the image, which is very convenient thereto. In addition, even in the dual display mode, when both the driver's seat side image and the passenger's seat side image are a navigation image which is important to both the driver and occupant, the sound mode may be set to the normal sound mode. In addition, when only the driver rides in the vehicle, the normal sound mode may be set to an optimum acoustic environment to the driver. Additionally, with both the driver's seat side image and the passenger's seat side image being a video image, when an optimum acoustic environment wants to be set for both the driver and the occupant, it may be good to configure that an automatic change of sound modes can be set and cancelled.

In addition, as a method for changing acoustic environments, the delay of output from the speakers, change in sound pressure, selection of speakers for output and the like are raised. Furthermore, a driver dedicated 6DS speaker may be provided in the vicinity of the driver's seat so as to reduce the effect on the passenger's seat of audio output for a driver's seat side image. As this occurs, a high directional frequency characteristic speaker such as an ultrasonic speaker is used as the driver dedicated speaker, whereby not only the front passenger's side sound is not affected but also a driver dedicated audio space can be produced. In this case, when the driver wants to listen to engine sound and running noise of the vehicle, clicking sound produced when a certain device is operated by the driver and the like, in addition to navigation guiding speeches, these sounds can be outputted from the driver dedicated speaker, whereby the driver can enjoy listening to the sounds without causing the occupant to hear them (without disturbing the occupant who is appreciating a vide image or the like). Furthermore, when wanting to decrease the level of sound to the passenger's seat, a microphone is placed and may be provided with a noise canceller function to generate a wave having an opposite phase to noise. In addition to these, in a vehicle such as a taxi in which a passenger rides in addition to the driver, navigation guiding speeches can be let known to only the driver without allowing the passenger to hear them, whereby the driver can be let known the guiding information in an ensured fashion without making the passenger uncomfortable.

Next, as another embodiment of a vehicle mounted display apparatus according to the invention, a case will be described in which a screen display of a vehicle mounted display apparatus which is to be operated to make a selection is made easy to be understood by the occupant or passenger PA who is less accustomed to operating the display apparatus than the driver DR. In general, although many drivers are accustomed to operating vehicle mounted display apparatus, there occurs a case where a occupant has never operated such a apparatus or is a child, and when it is the case, in many cases, they are not accustomed to operating the vehicle mounted apparatus. Because of this, when the occupant operates the apparatus, although the occupant can operate the apparatus by an instruction from the driver who is looking at a navigation image in the single display mode, in the event that the driver cannot see the navigation image in the dual display mode, a control display image becomes necessary in which more consideration is given to the occupant.

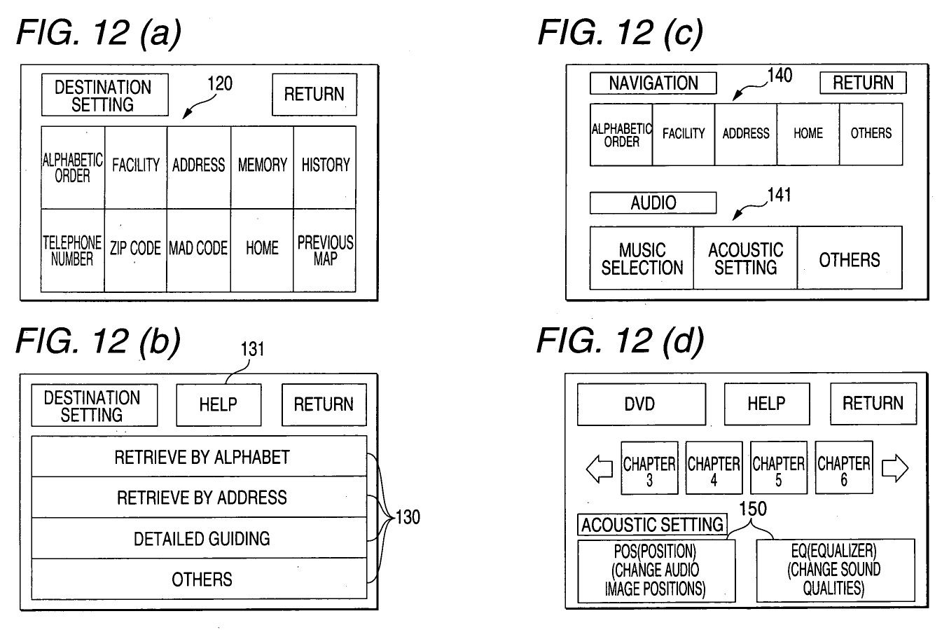

A processing flow of the display device 34 is shown in FIG. 11. Firstly, the display mode is determined (ST11), and if the display mode is determined to be the dual display mode, a control right condition is determined where which of the driver's seat side image IM1 and the passenger's seat side image IM2 can be controlled (ST12). If the control right is determined to be on the passenger's seat side in ST12, a display screen such as showing controls to be selected is switched to a control image for the passenger's seat (ST13), whereas if the display mode is determined to be the single display mode in ST11 or the control right is determined to be on the driver's seat side in ST12, a normal control image (ST14) is displayed. By adopting this configuration, even when the driver cannot instruct the occupant by looking at a navigation image in the dual display mode, the display can be implemented on the screen which does not mislead the occupant in controlling the apparatus who makes selection or decision in navigation. When used here, a normal control image means a display image such as a destination setting image shown in FIG. 12(a) which is expected to be controlled by the driver, and in this case, since the control image is expected to be operated while the vehicle is running, many detailed pieces of information 120 are displayed on a single screen so as to decrease the number of times of operation. On the other hand, a passenger's seat control image means an image which is expected to be controlled by the occupant, and since the occupant is not driving the vehicle, the passenger's seat control image is made to be a display in which importance is placed on easy understanding rather than the decrease in the number of times of operation. For example, as is shown in FIG. 12(b), selection buttons 130 for information which is used more frequently are made to displayed largely, and the occupant who is not accustomed to the apparatus is allowed to access a display of explanations via a help display 131. In addition, as to other than the operations for navigation, as is shown in FIG. 12(c), navigation control buttons 140 and audio apparatus control buttons 141 are displayed on the same screen, or as is shown in FIG. 12(d), a “POS” button 150 may be made to display such full wording as reading “POSITION: change the position of audio image” without any omission to indicate its function. By adopting this configuration, the convenience in controlling the acoustic setting is enhanced, whereby the display can be implemented in which more consideration is given to the occupant. In addition, a setting change as has been described above may be implemented in controlling the selection of control rights. In this way, by making the screen which is controlled by the occupant easier to be understood than the normal control screen, the occupant can implement the control easily. Note that in this embodiment, since the occupant is less accustomed to controlling the apparatus, the control screen which is controlled by the occupant is made to be displayed in the simple fashion, in the event that the occupant is accustomed to controlling the apparatus, the relevant screen can be made to be a control screen which contains more information, so that the screen controlled by the occupant can be set to a display which matches the controlling level of the controller.

Note that the vehicle mounted apparatus 2 in the embodiments may be integral with the display unit 100 or be separated from the display unit 100 in such a manner as to be connected thereto. In addition, the single display may be implemented by nullifying or removing the effect of the parallax barrier 115.

What is claimed is:

1. A vehicle mounted display apparatus, comprising:
a display operable to simultaneously display, on a single screen, a first image in a direction of a driver's seat based on a first image source, and a second image in a direction of a passenger's seat based on one of the first image source and a second image source; and
a sound controller operable to localize a sound image corresponding to at least one of the first image and the second image, wherein:
the sound controller localizes the sound image corresponding to the second image based on a type of the second image source in a case where the second image is displayed based on the second image source.

2. The vehicle mounted display apparatus as set forth in claim 1, wherein:
the sound controller localizes the sound image to the passenger's seat in a case where the type of the second image source is a video source of a DVD or a video source of a television.

3. The vehicle mounted display apparatus as set forth in claim 1, wherein:
the sound controller includes a sound mode selecting section operable to select, based on the type of the second image source, one of a normal sound mode in which the sound image is localized to at least a position between the driver's seat and the passenger's seat, and a passenger's seat sound mode in which the position of the sound image is localized to at least the passenger's seat.

4. The vehicle mounted display apparatus as set forth in claim 1, further comprising:
a display mode switching section operable to switch a display mode between a single display mode in which the second image is displayed based on the first image source and a dual display mode in which the second image is displayed based on the first image source;
a display mode judging section operable to judge the display mode;
a source judging section judging the type of the second source in a case where the display mode judging section judges the display mode is the dual display mode.

5. The vehicle mounted display apparatus as set forth in claim 4, wherein:
the sound mode selecting section selects the passenger seat sound mode in a case where the source judging section judges that the type of the second source is a video source of a DVD or a video source of a television.

6. The vehicle mounted display apparatus as set forth in claim 4, wherein:
the sound mode selecting section selects the normal sound mode in a case where the source judging section judges that the type of the second source is a navigation image.

7. The vehicle mounted display apparatus as set forth in claim 4, wherein:
the sound mode selecting section selects the normal sound mode in a case where only a driver rides in a vehicle.

8. The vehicle mounted display apparatus as set forth in claim 1, further comprising:
a speaker disposed in the vicinity of the driver's seat, and operable to output a navigation guiding sound.

9. The vehicle mounted display apparatus as set forth in claim 1, further comprising:
a speaker disposed in the vicinity of the driver's seat and operable to output a sound corresponding to the first image.

10. A sound controlling method for a vehicle mounted display apparatus having a display operable to simultaneously display, on a single screen, a first image in a direction of a driver's seat based on a first image source and a second image in a direction of a passenger's seat based on one of the first image source and a second image source, the sound control method comprising:
judging whether the second image is displayed based on the first source or the second source;
judging a type of the second source in a case where the second image is displayed based on the second source;
localizing a sound image corresponding to one of the first image and the second image to at least the passenger's seat in a case where the type of the second source is a video source;
localizing the sound image to at least a position between the driver's seat and the passenger's seat in a case where the type of the second source is not the video source.

11. The sound controlling method as set forth in claim 10, wherein:
the video source is a video source of a DVD or a video source of a television.

12. The sound controlling method as set forth in claim 10, wherein:
the type of the second source includes a navigation image.

13. The sound controlling method as set forth in claim 10, further comprising:
detecting a number of passengers;
localizing the sound image to at least the position between the driver's seat and the passenger's seat in a case where the number of the passengers is one.
